(19) United States
(12) Patent Application Publication
(10) Pub. No.: US 2025/0296516 A1
(43) Pub. Date: Sep. 25, 2025

(54) VEHICLE EXTERIOR COMPONENT

(71) Applicant: TOYODA GOSEI CO., LTD., Kiyosu-shi (JP)

(72) Inventors: Tatsuya SUGIURA, Kiyosu-shi (JP); Kimitoshi IMURA, Kiyosu-shi (JP); Tsubasa ISHIKAWA, Kariya-shi (JP)

(21) Appl. No.: 19/067,140

(22) Filed: Feb. 28, 2025

(30) Foreign Application Priority Data
Mar. 21, 2024 (JP) 2024-045319

(51) Int. Cl. B60R 13/04; B32B 3/26; B32B 3/30; B32B 15/08; B60R 19/52

(52) U.S. Cl. CPC B60R 13/04; B32B 3/266; B32B 3/30; B32B 15/08; B32B 2451/00; B32B 2605/00; B60R 19/52

(57) ABSTRACT

A vehicle exterior component includes an exterior member and a decorative member. The exterior member includes at least one through-hole. The decorative member includes a resin substrate including at least one base portion and a decorative layer laminated on an outer surface of the at least one base portion. The resin substrate includes two gate marks respectively provided at two ends of the resin substrate, and an elongated hole extending in an extending direction that intersects an arrangement direction of the two gate marks. The elongated hole is adjacent to the base portion in the arrangement direction and extends outward beyond opposite ends of the base portion in the extending direction. The elongated hole is not exposed to an outside of the vehicle.

### CROSS-REFERENCE TO RELATED APPLICATIONS

This application is based upon and claims the benefit of priority from Japanese Patent Application No. 2024-045319, filed on Mar. 21, 2024, the entire contents of which are incorporated herein by reference.

### BACKGROUND

### 1. Field

The present disclosure relates to a vehicle exterior component.

### 2. Description of Related Art

Japanese Laid-Open Patent Publication No. 2019-48559 discloses a radiator grille as a decorative member. The radiator grille disclosed in the publication includes a surface member and a decorative substrate provided on the rear side of the vehicle relative to the surface member. The surface member has the shape of plate having a large number of through-holes. The decorative substrate includes a strip-shaped substrate base extending in the width direction of the vehicle, protrusions protruding from the substrate base toward the front of the vehicle, and a decorative layer laminated on distal end surfaces of the protrusions. The protrusions are spaced apart from each other in the vehicle width direction. The protrusions are respectively located to overlap the through-holes of the surface member in the front-rear direction. The base substrate and the protrusions are integrally formed from resin. The decorative layer is formed through hot stamping.

The substrate base and protrusions (hereinafter referred to as the resin substrate) of the decorative member as disclosed in the above-described publication are formed by supplying molten resin into a mold. Since the resin substrate has the form of a strip extending in the vehicle width direction, molten resin is supplied to the mold from two gates, which are respectively provided at the parts corresponding to the two sides of the resin substrate in the vehicle width direction. In this case, weld lines, which are traces of molding defects formed at the merging section of molten resins that have flowed into the mold from the two gates, are likely to occur. Such weld lines, when formed on the protrusions, may impair the appearance of the decorative layer laminated on the distal end surfaces of the protrusions.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

A vehicle exterior component according to an aspect of the present disclosure includes an exterior member that forms part of an outer shell of a vehicle, and a decorative member provided on an inner side of the vehicle relative to the exterior member and arranged to face the exterior member. The exterior member includes at least one through-hole that extends through the exterior member in a facing direction in which the decorative member faces the exterior member. The decorative member includes a resin substrate including at least one base portion provided at a position overlapping the at least one through-hole in the facing direction, and a decorative layer laminated on an outer surface of the at least one base portion. The resin substrate includes two gate marks respectively provided at two ends of the resin substrate, and an elongated hole extending in an extending direction that intersects an arrangement direction of the two gate marks in a planar direction of the resin substrate. The elongated hole extends through the resin substrate in the facing direction. The elongated hole is adjacent to the base portion in the arrangement direction and extends outward beyond opposite ends of the base portion in the extending direction. The elongated hole is located at a position overlapping the exterior member in the facing direction so as not to be exposed to an outside of the vehicle.

Other features and aspects will be apparent from the following detailed description, the drawings, and the claims.

### BRIEF DESCRIPTION OF THE DRAWINGS

FIG. 1 is a front view showing a vehicle exterior component according to the present embodiment.

FIG. 2 is a rear view of the vehicle exterior component shown in FIG. 1.

FIG. 3 is a rear view of the bumper cover shown in FIG. 2.

FIG. 4 is a front view of the resin substrate shown in FIG. 2.

FIG. 5 is a rear view of the resin substrate shown in FIG. 4.

FIG. 6 is a rear view of the reinforcement member shown in FIG. 2.

Throughout the drawings and the detailed description, the same reference numerals

refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

In this specification, “at least one of A and B” should be understood to mean “only A, only B, or both A and B.”

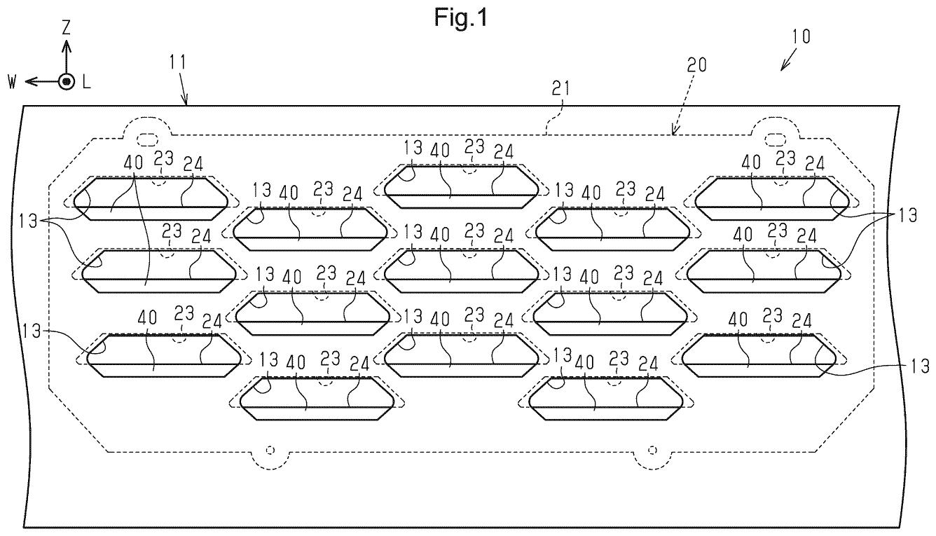

A vehicle exterior component according to an embodiment will now be described with reference to FIGS. 1 to 6.

In the description hereafter, the front-rear direction of the vehicle is referred to as the front-rear direction L. The width direction of the vehicle is referred to as the vehicle width direction W. The vertical direction of the vehicle when the vehicle is located on a horizontal plane is referred to as the vertical direction Z.

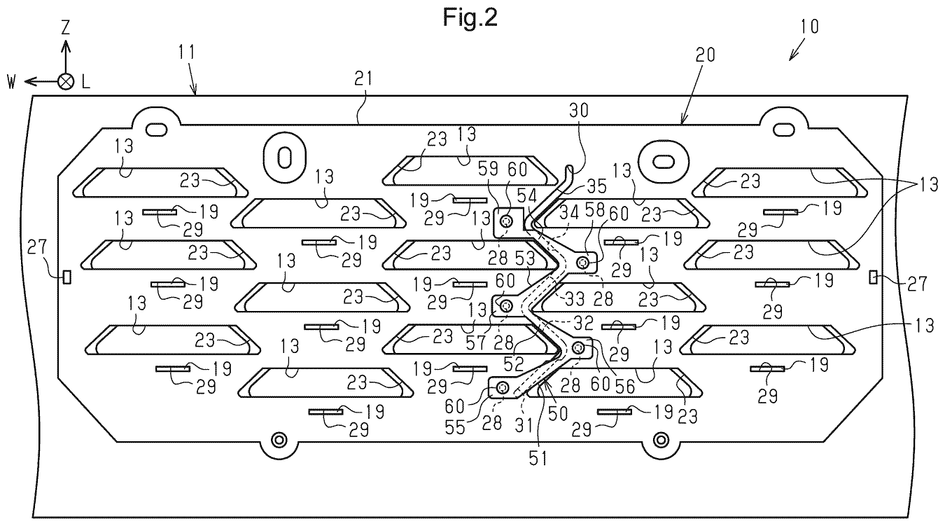

As shown in FIGS. 1 and 2, the vehicle exterior component 10 includes a bumper cover 11, a grille 20, and a reinforcement member 50.

Bumper Cover 11

As shown in FIG. 1, the bumper cover 11 is a front bumper cover that forms part of the outer shell of the vehicle on the front side.

The bumper cover 11 has through-holes 13, each extending through the bumper cover 11 in the front-rear direction L. The through-holes 13 each have a hexagonal shape as viewed from the front. The through-holes 13 are arranged in a grid pattern. The through-holes 13 include through-holes 13 arranged in the vertical direction Z. The through-holes 13 also include through-holes 13 arranged in the vehicle width direction W. The through-holes 13 are arranged such that the vertical positions of adjacent ones of the through-holes 13 alternate in the vehicle width direction W. In the present embodiment, three through-holes 13 are arranged in the vertical direction Z, and five through-holes 13 are arranged in the vehicle width direction W.

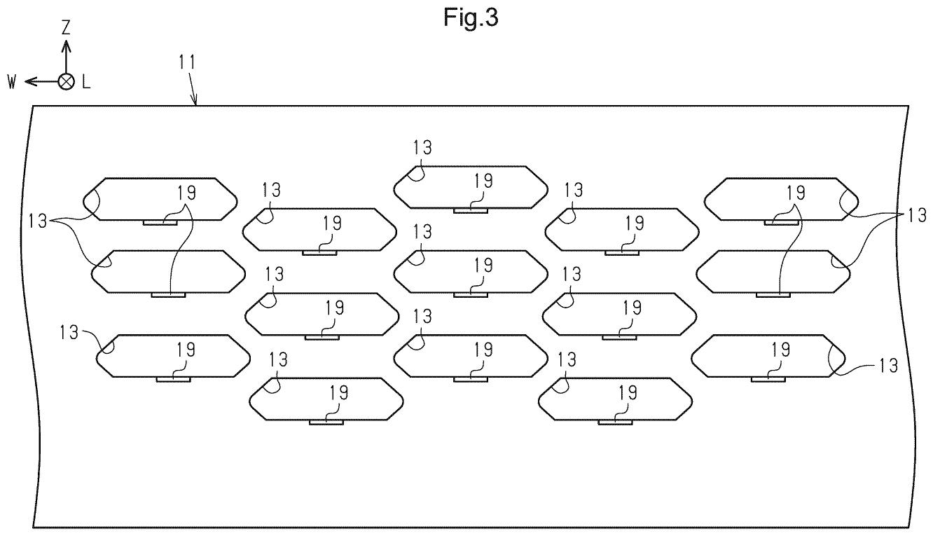

As shown in FIG. 3, the bumper cover 11 includes engaging tabs 19 that protrude rearward from the rear surface of the bumper cover 11. The engaging tabs 19 are provided on peripheral portions of the lower edge of the through-holes 13, respectively.

Grille 20

As shown in FIGS. 1 and 2, the grille 20 is located on the inner side of the vehicle relative to the bumper cover 11 and arranged to face the bumper cover 11 in the front-rear direction L. The grille 20 is mounted on the rear surface of the bumper cover 11 by fasteners (not shown).

As shown in FIG. 1, the grille 20 includes a resin substrate 21 and decorative layers 40.

Resin Substrate 21

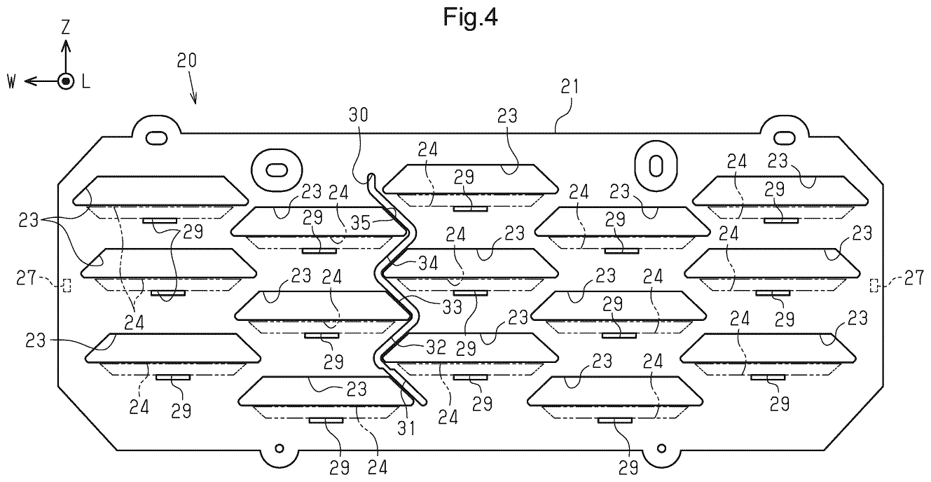

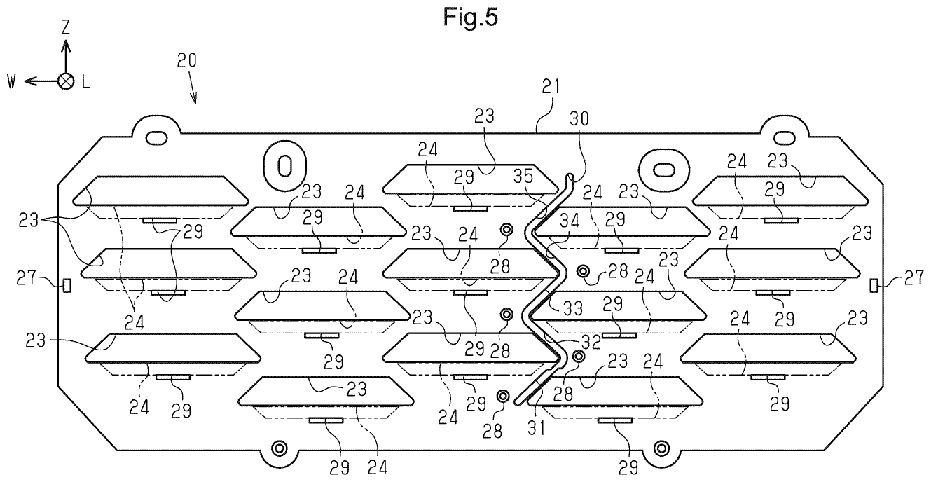

As shown in FIGS. 4 and 5, the resin substrate 21 has the shape of an elongated plate that extends in the vehicle width direction W.

The resin substrate 21 is made of thermoplastic resin.

As shown in FIGS. 1 and 2, connection holes 23 are provided in the resin substrate 21 at positions respectively corresponding to the through-holes 13. The connection holes 23 each have a trapezoidal shape as viewed from the front and extend outward beyond the two edges of the corresponding through-hole 13 in the vehicle width direction W. The upper edge of the connection hole 23 extends along the upper edge of the through-hole 13. The lower edge of the connection hole 23 is located above the lower edge of the through-hole 13.

As shown in FIGS. 2, 4, and 5, engagement holes 29 are provided in the resin substrate 21 at positions respectively corresponding to the engaging tabs 19. The grille 20 is positioned relative to the bumper cover 11 by the engagement of the engaging tabs 19 with the engagement holes 29.

As shown in FIGS. 4 and 5, the resin substrate 21 includes a base portion 24 located at a position overlapping each through-hole 13 in the front-rear direction L, a gate mark 27 provided at each of the two ends of the resin substrate 21 in the vehicle width direction W, and an elongated hole 30.

As shown in FIG. 1, the base portions 24 are respectively located at the positions corresponding to the through-holes 13. Each base portion 24 is a portion of the resin substrate 21 that is defined by the lower edge of the connection hole 23 and the periphery of the through-hole 13. The base portions 24 include base portions 24 that are arranged in the vertical direction Z. In the present embodiment, three base portions 24 are arranged in the vertical direction Z.

The portion of the resin substrate 21 except the base portions 24 is covered from the front of the vehicle by the bumper cover 11.

As shown in FIG. 5, two gate marks 27 are respectively located outward from outermost ones of the base portion 24, and located at the center of the resin substrate 21 in the vertical direction Z.

The elongated hole 30 extends in an extending direction (i.e., the vertical direction Z) intersecting the vehicle width direction W in a planar direction of the resin substrate 21, and extends through the resin substrate 21 in the front-rear direction L. Further, the elongated hole 30 is adjacent to the base portions 24 in the vehicle width direction W and extends outward beyond opposite ends of the base portions 24 in the vertical direction Z. Furthermore, the elongated hole 30 is located at a position overlapping the bumper cover 11 in the front-rear direction L so as not to be exposed to the outside of the vehicle. The elongated hole 30 is provided between adjacent ones of the base portions 24 in the vehicle width direction W. Preferably, the elongated hole 30 extends over the entirety of the base portions 24 arranged in the vertical direction Z. In the present embodiment, the elongated hole 30 is adjacent to, in the vehicle width direction W, the three base portions 24 arranged in the vertical direction Z in the middle of the resin substrate 21, and extends over the entirety of the three base portions 24. Additionally, the elongated hole 30 is provided between the three base portions 24 located at the middle of the resin substrate 21 in the vehicle width direction W and the three base portions 24 adjacent thereto on one side (the right side in FIG. 5) in the vehicle width direction W.

The elongated hole 30 includes, in order from the bottom, a first hole portion 31, a second hole portion 32, a third hole portion 33, a fourth hole portion 34, and a fifth hole portion 35.

The first hole portion 31 is inclined such that a higher part of the first hole portion 31 in the vertical direction Z extends farther, in the vehicle width direction W, from the center of the resin substrate 21 in the vehicle width direction W.

The second hole portion 32 is continuous with the upper end of the first hole portion 31 and inclined such that a higher part of the second hole portion 32 in the vertical direction Z approaches, in the vehicle width direction W, the center of the resin substrate 21 in the vehicle width direction W.

The third hole portion 33 is continuous with the upper end of the second hole portion 32 and inclined such that a higher part of the third hole portion 33 in the vertical direction Z extends farther, in the vehicle width direction W, from the center of the resin substrate 21 in the vehicle width direction W.

The fourth hole portion 34 is continuous with the upper end of the third hole portion 33 and inclined such that a higher part of the fourth hole portion 34 in the vertical direction Z approaches, in the vehicle width direction W, the center of the resin substrate 21 in the vehicle width direction W.

The fifth hole portion 35 is continuous with the upper end of the fourth hole portion 34. The fifth hole portion 35 includes a basal end portion inclined so as to extend farther, in the vehicle width direction W, from the center of the resin substrate 21 in the vehicle width direction W, and a distal end portion extending from the upper end of the basal end portion in the vertical direction Z.

Decorative Layer 40

As shown in FIG. 1, each decorative layer 40 is laminated on the outer surface of the corresponding base portion 24.

The decorative layer 40 is a hot stamp layer where a metal foil is thermally transferred to the outer surface of the base portion 24.

As shown in FIG. 5, the resin substrate 21 includes attachments 28 that protrude rearward from the rear surface of the resin substrate 21. Each attachment 28 has a hole that opens rearward. The attachments 28 are located adjacent to the lower end of the first hole portion 31, the portion where the first hole portion 31 is connected to the second hole portion 32, the portion where the second hole portion 32 is connected to the third hole portion 33, the portion where the third hole portion 33 is connected to the fourth hole portion 34, and the portion where the fourth hole portion 34 is connected to the fifth hole portion 35, respectively.

Reinforcement Member 50

As shown in FIG. 2, the reinforcement member 50 is mounted on the resin substrate 21 to cover the elongated hole 30 from the inner side of the vehicle.

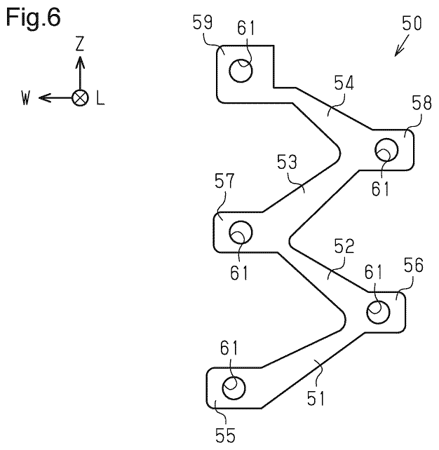

As shown in FIG. 6, the reinforcement member 50 includes a first arm 51, a second arm 52, a third arm 53, a fourth arm 54, a first attachment piece 55, a second attachment piece 56, a third attachment piece 57, a fourth attachment piece 58, and a fifth attachment piece 59.

As shown in FIG. 2, the first attachment piece 55, the second attachment piece 56, the third attachment piece 57, the fourth attachment piece 58, and the fifth attachment piece 59 are respectively provided at positions corresponding to the attachments 28 of the resin substrate 21. The first attachment piece 55, the second attachment piece 56, the third attachment piece 57, the fourth attachment piece 58, and the fifth attachment piece 59 each have an attachment hole 61 (refer to FIG. 6). Screws 60 respectively inserted through the attachment holes 61 are threaded into the holes of the attachments 28, thereby fastening the resin substrate 21 to the reinforcement member 50.

The first arm 51 extends along the first hole portion 31 and couples the first attachment piece 55 to the second attachment piece 56.

The second arm 52 extends along the second hole portion 32 and couples the second attachment piece 56 to the third attachment piece 57.

The third arm 53 extends along the third hole portion 33 and couples the third attachment piece 57 to the fourth attachment piece 58.

The fourth arm 54 extends along the fourth hole portion 34 and couples the fourth attachment piece 58 to the fifth attachment piece 59.

In the present embodiment, the bumper cover 11 and the grille 20 correspond to the exterior member and the decorative member according to the present disclosure, respectively. In the present embodiment, the front-rear direction L and the vehicle width direction W correspond to the facing direction and the arrangement direction according to the present disclosure, respectively.

### Operation of Present Embodiment

Referring to FIG. 5, molten resin is supplied from gates into a mold to form the resin substrate 21. In this case, the gate marks 27, from which the portions corresponding to the gates have been respectively removed, are formed on the resin substrate 21. The elongated hole 30 is adjacent to the base portions 24 of the resin substrate 21 in the vehicle width direction W, and extends outward beyond the opposite ends of the base portions 24 in the vertical direction Z. Thus, when molten resin is supplied to the mold through two gates to form the resin substrate 21, the following effect is gained. The portion of the molding surface of the mold that forms the elongated hole 30 (i.e., a separating wall) prevents molten resins supplied from the gates from merging at the portion of the cavity in the mold that forms the base portion 24.

### Advantages of Present Embodiment

(1) The elongated hole 30 is adjacent to the base portions 24 in the vehicle width direction W, and extends outward beyond the opposite ends of the base portions 24 in the vertical direction Z. Further, the elongated hole 30 is located at the position overlapping the bumper cover 11 in the front-rear direction L so as not be exposed to the outside of the vehicle.

This configuration operates in the above-described manner, and thus prevents weld lines from forming on the base portion 24.

(2) The resin substrate 21 has an elongated shape. The two gate marks 27 are respectively provided at the two ends of the resin substrate 21 in the vehicle width direction W.

If the resin substrate 21 has an elongated shape, during formation of the resin substrate 21, gates may be respectively provided at positions corresponding to the two ends of the mold in the longitudinal direction of the resin substrate 21. In such a case, molten resins supplied from the gates may be likely to be cooled until they merge.

In the above-described configuration, the resin substrate 21 has an elongated shape, and includes the two gate marks 27 respectively formed at two longitudinal ends of the resin substrate 21 (i.e., the two ends of the resin substrate 21 in the vehicle width direction W). This prevents weld lines from forming on the base portions 24.

(3) The base portions 24 are provided on each of the two sides of the elongated hole 30 in the vehicle width direction W.

In this configuration, in the resin substrate 21, the base portions 24 are provided on each of the two sides of the elongated hole 30 in the vehicle width direction W. This prevents weld lines from forming on each of the base portions 24.

(4) The elongated hole 30 extends over the entirety of the base portions 24 arranged in the vertical direction Z.

In the resin substrate 21, the base portions 24 are arranged in the vertical direction Z. In such a resin substrate 21, if each base portion 24 has an elongated hole 30, there is a risk that molten resin may pass through the space between the portions of the molding surface of the mold that forms the elongated holes 30 (i.e., through the space between separating walls). As a result, the merging of molten resins may be unable to be prevented.

In the above-described configuration, in the resin substrate 21, the base portions 24 are arranged in the vertical direction Z. This prevents the formation of weld lines on each of the base portions 24.

(5) The decorative layer 40 is a hot stamp layer.

Generally, the thickness of a hot stamp is thinner than a coating or plating. Therefore, when a hot stamp layer serving as the decorative layer 40 is formed on the outer surface of the base portion 24 where a weld line has occurred, the weld line is likely to be transferred to the decorative layer 40, leading to appearance defects.

The above-described configuration prevents weld lines from forming on the base portion 24. This prevents appearance defects in the decorative layer 40.

(6) The vehicle exterior component 10 includes the reinforcement member 50 attached to the resin substrate 21. The reinforcement member 50 covers the elongated hole 30 from the inner side of the vehicle.

The formation of the elongated hole 30 in the resin substrate 21 reduces the rigidity of the resin substrate 21 and, consequently, the rigidity of the grille 20.

In the above-described configuration, the reinforcement member 50 is attached to the resin substrate 21 as described above. This prevents the reduction in the rigidity of the resin substrate 21 and, consequently, the rigidity of the grille 20.

### Modifications

The present embodiment may be modified as follows. The present embodiment and the following modifications can be combined as long as they remain technically consistent with each other.

In the above-described embodiment, the reinforcement member 50 is attached to the resin substrate 21 to cover the elongated hole 30 from the inner side of the vehicle. Instead, if the reduction in the rigidity of the resin substrate 21 caused by the elongated hole 30 is relatively small, the reinforcement member 50 may be omitted.

In the above-described embodiment, the decorative layer 40 is a hot stamp layer. Instead, the decorative layer 40 may be a coating film or a plating layer.

In the above-described embodiment, the elongated hole 30 extends over the entirety of the base portions 24 arranged in the vertical direction Z. Instead, the elongated hole 30 may be provided so as to be adjacent to some of the base portions 24 arranged in the vertical direction Z.

In the above-described embodiment, the base portions 24 are provided on each of the two sides of the elongated hole 30 in the vehicle width direction W. Instead, the base portions 24 may be provided only on one side of the elongated hole 30 in the vehicle width direction W.

In the above-described embodiment, the two gate marks 27 are respectively formed at the two ends of the resin substrate 21 in the vehicle width direction W. Instead, the two gate marks 27 may be respectively formed at the two ends of the resin substrate 21 in the vertical direction Z.

In the above-described embodiment, the resin substrate 21 has an elongated shape extending in the vehicle width direction W. Instead, the resin substrate 21 may have an elongated shape extending in the vertical direction Z.

In the above-described embodiment, the elongated hole 30 is adjacent to the base portions 24 arranged in the vertical direction Z. Instead, the elongated hole 30 may be adjacent to one base portion 24.

In the above-described embodiment, the two gate marks 27 are respectively provided only at the two ends of the resin substrate 21 in the vehicle width direction W. Instead, If the flow direction of the molten resin from the gates that form the two gate marks 27 aligns with the main flow of resin within the mold, additional gates may be provided at other locations.

In the above-described embodiment, the resin substrate 21 has the shape of an elongated plate. Instead, the resin substrate 21 may have the shape of, for example, a square plate as viewed from the front.

In the above-described embodiment, the vehicle exterior component 10 is formed by the assembly of the front bumper cover and the grille. Instead, the vehicle exterior component 10 may be formed by, for example, the assembly of a rear bumper cover that has a through-hole and a decorative member that is located inward from the rear bumper cover. In this case, a hole does not have to be provided in the decorative member at a position overlapping the through-hole of the rear bumper cover in the front-rear direction L.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

1. A vehicle exterior component, comprising:
an exterior member that forms part of an outer shell of a vehicle; and
a decorative member provided on an inner side of the vehicle relative to the exterior member and arranged to face the exterior member, wherein
the exterior member includes at least one through-hole that extends through the exterior member in a facing direction in which the decorative member faces the exterior member,
the decorative member includes:
a resin substrate including at least one base portion provided at a position overlapping the at least one through-hole in the facing direction; and
a decorative layer laminated on an outer surface of the at least one base portion, and
the resin substrate includes:
two gate marks respectively provided at two ends of the resin substrate; and
an elongated hole extending in an extending direction that intersects an arrangement direction of the two gate marks in a planar direction of the resin substrate, the elongated hole extending through the resin substrate in the facing direction, and
the elongated hole is adjacent to the base portion in the arrangement direction and extends outward beyond opposite ends of the base portion in the extending direction, the elongated hole being located at a position overlapping the exterior member in the facing direction so as not to be exposed to an outside of the vehicle.

2. The vehicle exterior component according to claim 1, wherein
the resin substrate has an elongated shape, and
the two gate marks are respectively provided at two longitudinal ends of the resin substrate.

3. The vehicle exterior component according to claim 2, wherein
the at least one through-hole is one of through-holes,
the at least one base portion is one of base portions respectively corresponding to the through-holes, and
the base portions are provided on two sides of the elongated hole in the arrangement direction.

4. The vehicle exterior component according to claim 2, wherein
the at least one through-hole is one of through-holes,
the at least one base portion is one of base portions respectively corresponding to the through-holes, and
the base portions include base portions arranged in the extending direction, and
the elongated hole extends over the entirety of the base portions arranged in the extending direction.

5. The vehicle exterior component according to claim 1, wherein
the decorative layer is a hot stamp layer.

6. The vehicle exterior component according to claim 1, further comprising a reinforcement member attached to the resin substrate, wherein
the reinforcement member covers the elongated hole from the inner side of the vehicle.
